(19) United States
(12) Patent Application Publication
(10) Pub. No.: US 2020/0217213 A1
(43) Pub. Date: Jul. 9, 2020

(54) CMC LAYERING WITH PLIES WITH INNER PORTION DEFINED WITH OPENING(S), AND NOZZLE ENDWALL

(71) Applicant: General Electric Company, Schenectady, NY (US)

(72) Inventors: Peter de Diego, Zirconia, NC (US); John McConnell Delvaux, Fountain Inn, SC (US); John Ellington Greene, Greenville, SC (US); David Randall Hobart, Cincinnati, OH (US); James Joseph Murray, III, Mauldin, SC (US)

(21) Appl. No.: 16/243,154

(22) Filed: Jan. 9, 2019

(51) Int. Cl. F01D 9/04; B28B 1/00

(52) U.S. Cl. CPC F01D 9/042; B28B 1/002; F05D 2240/12; F05D 2300/6033; F05D 2230/31

(57) ABSTRACT

A method of layering ceramic matrix composite (CMC) plies during a build of a component is disclosed. The method may include creating a plurality of CMC plies for creating the component. At least a first plurality of the plurality of the CMC plies each define both an outer portion and an inner portion of the component, each inner portion being defined within the outer portion by one or more openings in the respective CMC ply. The method may also include layering the plurality of CMC plies, and infiltrating the CMC plies with a binder to form the component. In one example, the component can be a turbine nozzle endwall.

This application was made with government support under contract number DE-FE0024006 awarded by the Department of Energy. The US government has certain rights in the invention.

### BACKGROUND OF THE INVENTION

The disclosure relates generally to ceramic matrix composites (CMCs), and more particularly, to a method of forming a CMC component using CMC plies that include an outer portion and an integral, spaced inner portion defined by opening(s) within the outer portion.

Industrial machine parts such as a turbine nozzle endwalls can be made by layering ceramic matrix composite (CMC) plies. For example, FIG. 1 shows conventional layering of CMC plies for a turbine nozzle endwall 10. Turbine nozzle endwall 10 generally includes an outer portion 12 that is, in this example, has an outer polygonal periphery, and an inner portion 14 that has an airfoil shaped interior opening 16 for engaging a radially inner or outer end of a metal airfoil of a turbine nozzle (not shown). As understood, an end face of turbine nozzle endwall 10 (facing down in FIG. 1) may curve from side-to-side to aid in directing hot gases in the turbine.

Formation of CMC turbine nozzle endwall 10 includes sequentially layering CMC layers that collectively define the endwall. As shown in the uppermost CMC layer in FIG. 1, each CMC layer may include a number of preforms 20 or partial CMC plies that collectively create a CMC layer for the endwall. In the example shown, five different preforms 20 can be positioned to create each CMC layer of nozzle endwall 10: a left outer portion preform 22, an upper outer portion preform 24, a right outer portion preform 26, a lower outer portion preform 28 and an inner portion preform 30. Inner portion preforms 30 form an airfoil shaped interior opening 16, and outer portion preforms 22, 24, 26, 28 eventually collectively constitute sides of outer portion 12 of the nozzle endwall.

Each preform 20 may have a different shape, height, length and/or thickness, relative to a corresponding preform in an adjacent layer to accommodate proper positioning and shaping of nozzle endwall 10. The number of CMC layers necessary to create nozzle endwall 10 can be relatively large, e.g., 100. In addition, the layering process can be very complex and tedious. For example, at the corners of nozzle endwall 10, outer portion preforms 22, 24, 26, 28 must overlap such that layers thereof sequence between being longer and shorter, and so they do not create a seam or stagger that can negatively impact the formation of the nozzle endwall. For example, outer portion preform 22 is shown longer and with ends 32 thereof extending to outer edges 33 of outer portion preforms 24, 28. Ends 34 of outer portion preforms 24, 28 meet with an inner side 36 of outer portion preform 22. In the next layer (not shown), outer portion preform 22 would be shorter with ends 32 thereof meeting with inner sides 38 of outer portion preforms 24, 28, while ends 34 of outer portion preforms 24, 28 would extend to an outer edge 40 of outer portion preform 22. Complicating the layering process further, as the layering of outer portion preforms 22, 24, 26, 28 occurs, inner portion preforms 30 are also being positioned so that nozzle endwall 10 can be created. Each preform 20 must be precisely positioned to allow for creation of the desired nozzle endwall.

### BRIEF DESCRIPTION OF THE INVENTION

A first aspect of the disclosure provides a method of layering ceramic matrix composite (CMC) plies during a build of a component, the method comprising: creating a plurality of CMC plies for creating the component, wherein at least a first plurality of the plurality of the CMC plies each define both an outer portion and an inner portion of the component, each inner portion being defined within the outer portion by one or more openings in the respective CMC ply; layering the plurality of CMC plies; and infiltrating the plurality of CMC plies with a binder to form the component.

A second aspect of the disclosure provides a method of layering ceramic matrix composite (CMC) plies during a build of turbine nozzle endwall, the method comprising: creating a plurality of CMC plies for creating the turbine nozzle endwall, wherein at least a first plurality of the plurality of the CMC plies each define both an outer portion and an inner, airfoil engaging portion of the turbine nozzle endwall, each inner, airfoil engaging portion being defined within the outer portion by one or more openings in the respective CMC ply, and wherein the inner, airfoil engaging portion has an internal airfoil-shaped opening; layering the plurality of CMC plies; and infiltrating the plurality of CMC plies with a binder to form the component.

A third aspect of the disclosure provides a turbine nozzle endwall, the endwall comprising: a plurality of CMC plies infiltrated with a binder, wherein at least a first plurality of the plurality of the CMC plies each define both an outer portion and an inner, airfoil engaging portion of the turbine nozzle endwall, each inner, airfoil engaging portion being defined within the outer portion by one or more openings in the respective CMC ply, and wherein the inner, airfoil engaging portion has an internal airfoil-shaped opening.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective view of conventional layering of CMC preforms to form a component.

FIG. 2 shows a perspective view of an illustrative component in the form of turbine nozzle, components of which may be formed according to embodiments of the disclosure.

FIG. 3 shows a perspective view of a CMC portion of a turbine nozzle endwall of the turbine nozzle, which is made according to embodiments of the disclosure.

FIG. 4 shows a plan view of a CMC ply according to embodiments of the disclosure.

FIG. 5 shows a plan view of a first plurality of CMC plies according to embodiments of the disclosure.

FIG. 6 shows a perspective view of layering a plurality of CMC plies, including the first plurality of CMC plies according to embodiments of the disclosure, and a second plurality of CMC plies.

FIG. 7 shows a cross-sectional view of the layering along line 7-7 in FIG. 6.

FIG. 8 shows a perspective view of a turbine nozzle endwall including a CMC portion made according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant components. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. As used herein, the term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. It will be appreciated that such terms may be applied in relation to the center axis of the turbine as it relates to a turbine nozzle.

Where an element or layer is referred to as being “on,” “engaged to,” “disengaged from,” “connected to” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As indicated above, the disclosure provides methods of layering ceramic matrix composite (CMC) plies during a build of a component. The method may include creating a plurality of CMC plies for creating the component in a different manner than is conventionally provided. More particularly, at least a first plurality of the plurality of the CMC plies used to create the component each define both an outer portion and an inner portion of the component. That is, rather than a number of small preforms being used to create an outer portion and an inner portion of a CMC layer, a single, integral CMC ply is created for each of a number of CMC layers. In contrast to conventional layering in which multiple smaller preforms are arranged to create the interior portion of the CMC layer, each inner portion is defined within the outer portion by one or more openings in the respective CMC ply. In other words, the inner portion is created by forming a negative representation thereof within the outer portion. The method may also include layering the plurality of CMC plies, and infiltrating the CMC plies with a binder to form the component.

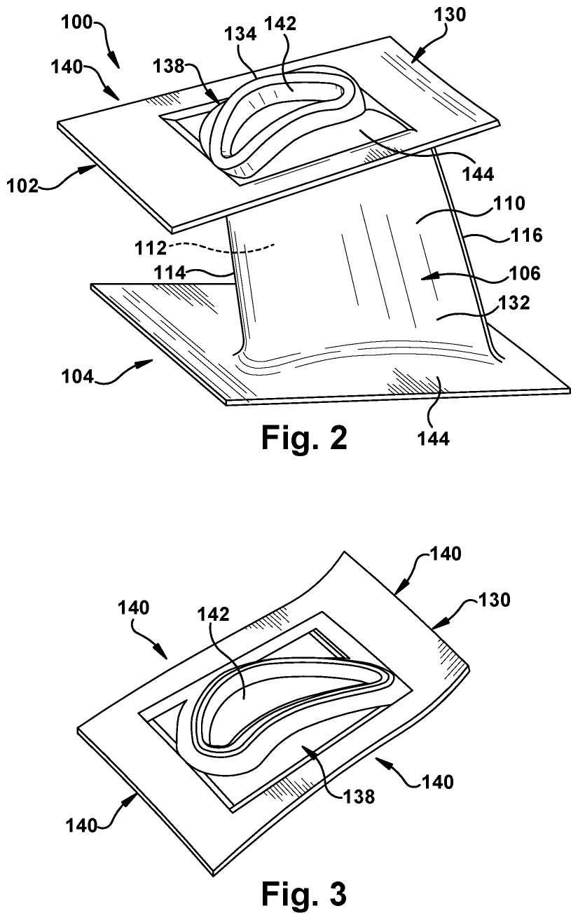

Embodiments of the disclosure will be described relative to forming an illustrative component in the form of a turbine nozzle endwall. It is understood, however, that the methods of the disclosure are applicable to a wide variety of CMC components. FIG. 2 shows a perspective view of a turbine nozzle 100 of the type in which embodiments of the present disclosure may be employed. Nozzle 100 includes an outer endwall 102 by which nozzle 100 attaches to stationary casing (not shown) of a turbomachine. Outer endwall 102 may include any now known or later developed mounting configuration for mounting in a corresponding mount in the casing. Nozzle 100 may further include an inner endwall 104 for positioning between adjacent turbine rotor blades (not shown). As understood in the art, nozzle endwalls 102, 104 define respective portions of the outboard and inboard boundary of the flow path through a turbine. It will be appreciated that an airfoil 106 is the active component of nozzle 100 intercepts the flow of working fluid and directs it towards the turbine rotor blades (not shown). It will be seen that airfoil 106 of turbine nozzle 100 includes a concave pressure side (PS) outer wall 110 and a circumferentially or laterally opposite convex suction side (SS) outer wall 112 extending axially between opposite leading and trailing edges 114, 116 respectively. Sidewalls 110 and 112 also extend in the radial direction from inner endwall 104 to outer endwall 102. It is understood that other features of nozzle 100, not described herein such as but not limited to internal cooling structures, cutout shape, outer wall angling/shape, etc., may be customized for the particular application.

FIG. 3 shows an enlarged perspective view of a CMC endwall portion 130 of endwalls 102, 104. A part or all of each nozzle endwall 102, 104 may be made of CMC material. In the instant example, only a portion of each endwall 102, 104 includes CMC. CMC portion 130 may include an inner portion 138, and an outer portion 140 that generally frames inner portion 138. Inner portion 138 includes an internal airfoil-shaped opening 142. Depending on the endwall for which it is built, internal airfoil-shaped opening 142 mates either a radially inner end 132 of airfoil 106 (FIG. 2) or a radially outer end 134 of airfoil 106 (FIG. 2). A portion 144 of nozzle endwalls 102, 104, i.e., a portion exposed to hot gases in a turbine, may be made of other material such as a metal, metal alloy or superalloy. As understood in the art, CMC portion 130 of nozzle endwall 101, 104 is made of any now known or later developed ceramic matrix composite configured to withstand the environment within the turbine.

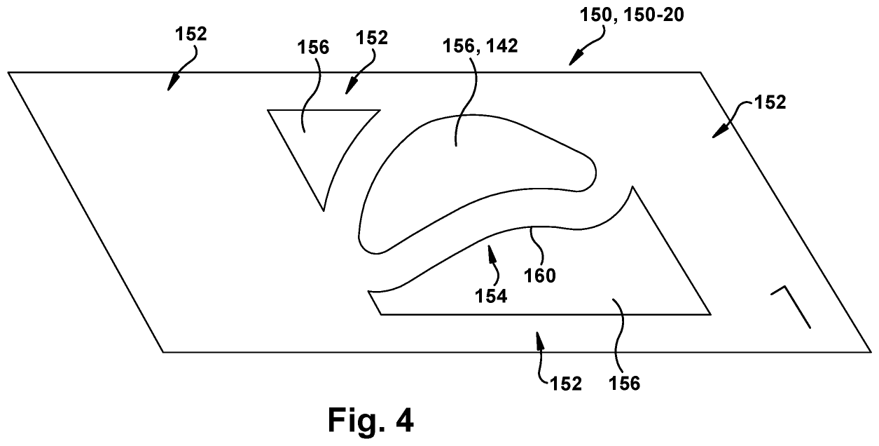

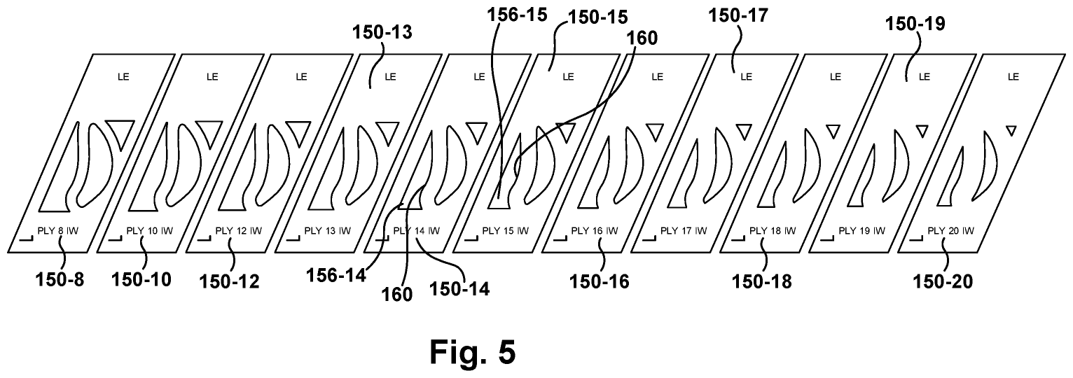

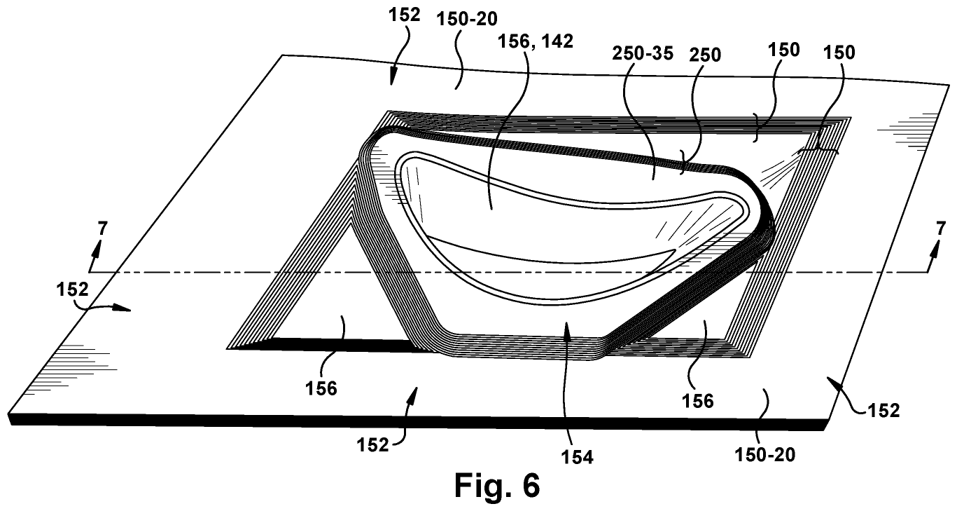

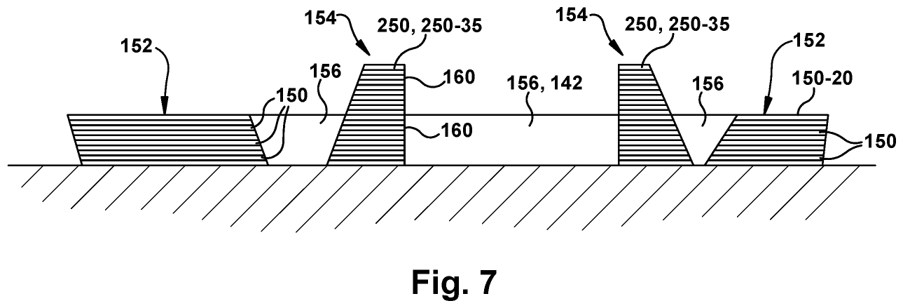

A method of layering CMC plies during a build of a component will now be described. As is understood in the art, CMC component formation includes creating and layering a plurality of layer of CMC plies that collectively create the desired shape of the component. Once layered, a binder can be injected into the CMC plies to create the component, and other curing and finishing processes can be provided to finalize the component. In accordance with embodiments of the disclosure a plurality of CMC layers 150, 250 are layered to create the component. FIG. 4 shows a plan view of one CMC ply 150-20, and FIG. 5 shows a schematic plan view of a first plurality of CMC plies 150, according to embodiments of the disclosure. FIG. 6 shows a perspective view of layering of a plurality of CMC plies 150, 250, and FIG. 7 shows a cross-sectional view of the layering along line 7-7 in FIG. 6. In the drawings, each CMC ply is denoted with reference 150-n or 250-n, where n denotes the CMC layer to which the CMC ply is applied. A first plurality of CMC plies that are formed according to embodiments of the disclosure are denoted with reference 150, while a second embodiment of CMC plies that may not be formed according to the disclosure are denoted with reference 250. Hence, CMC plies 150-13 and 150-20 (FIG. 5) would be formed according to embodiments of the disclosure and would be in CMC layer 13 and CMC layer 20, respectively, of the layering for the component, and CMC ply 250-35 (FIG. 6) may not be formed according to embodiments of the disclosure and would be in the 35^{th} CMC layer of the component. As can be observed in FIG. 6, CMC plies from the different pluralities 150, 250 need not be provided in every CMC layer. FIG. 5 shows a series of the first plurality of CMC plies 150 in which each CMC ply 150 may be slightly different than a next adjacent CMC ply 150 to collectively form part of the component. FIG. 5 shows only a first plurality (denoted 150) of a total plurality of CMC plies 150, 250 that may be employed.

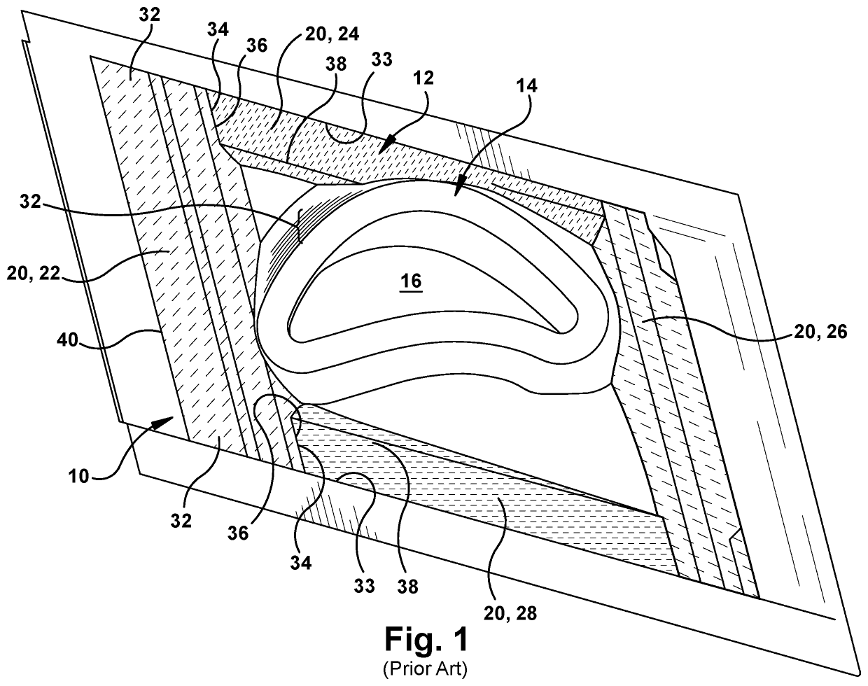

In accordance with embodiments of the disclosure, a plurality of CMC plies 150, 250 are created for creating the component. In contrast to conventional CMC plies, at least a first plurality of the plurality of the CMC plies 150, as shown in FIGS. 4 and 5, each define both an outer portion 152 and an inner portion 154 of the component. Further, each inner portion 154 is defined within outer portion 152 by one or more openings 156 in the respective CMC ply 150. One of openings 156 may provide internal airfoil-shaped opening 142. Other openings 156, however, act to create inner portion 154 of the component. In the example used, the inner portion provides the structure including internal airfoil-shaped opening 142, creating an inner, airfoil engaging portion of nozzle endwall 102, 104, and also an outer surface 160 that is airfoil shaped in a generally horizontal cross-section. In other words, one or more openings 156 in each CMC ply 150 define a negative representation of inner portion 154 of the component. Hence, each CMC ply 150 provides an integral inner portion 154 and outer portion 152, e.g., framing the inner portion, with a single, integrated CMC ply. In this manner, rather than having to layer a large number of preforms in a complex and tedious process, a single, integrated CMC ply 150 is employed to reduce the number of preforms necessary. For the illustrative nozzle endwalls 102, 104 (FIG. 1), the number of CMC layers required to build a particular portion of the component may be greatly reduced, e.g., from 100 to 20.

FIG. 5 shows first plurality of CMC plies 150 illustrating that at least one of opening(s) 156 in a respective CMC ply 150 includes an offset step relative to a corresponding one or more openings 156 in an adjacent CMC ply 150. For example, as can be observed by comparing opening 156 in CMC ply 150-14 versus opening 156 in CMC ply 150-15, opening 156-14 is shifted/stepped compared to opening 156-15, allowing for changing of the shape of the structure formed by the CMC plies. In this example, outer surface 160 of inner portion 154 would change in shape. As understood, over a number of CMC layers 150, changing of the shape of openings 156 allows for changing of the shape of the structure created by the layering of the CMC plies.

Referring to FIGS. 6 and 7, layering of plurality of CMC plies, including first plurality of CMC plies 150 and a second plurality of CMC plies 250, is shown. As can be observed best in FIG. 7, at least a second plurality of the plurality of the CMC plies 250 may define at least a section of just one of outer portion 152 and inner portion 154. In the example shown in FIGS. 6 and 7, CMC plies 250 provide additional layers to inner portion 154, i.e., including internal airfoil-shaped opening 142, above a last CMC ply 150-20 of the first plurality of CMC plies.

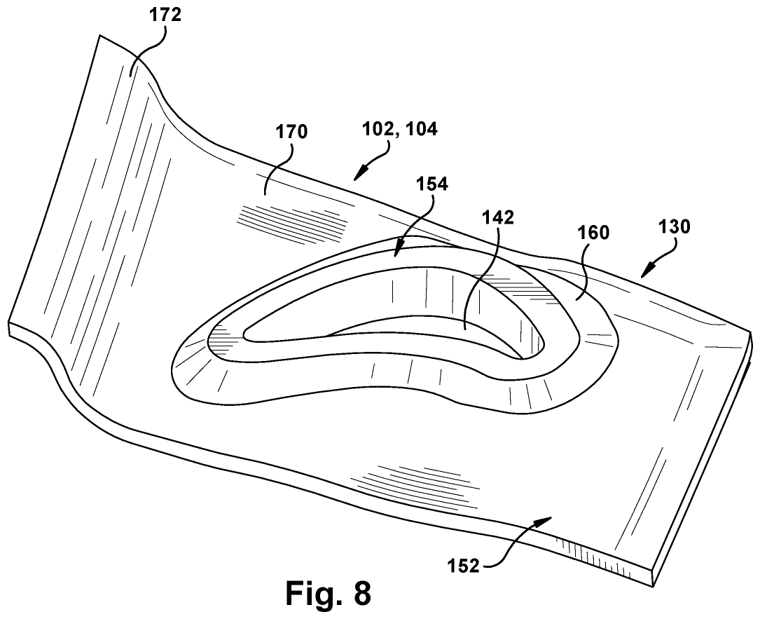

FIG. 8 shows a perspective view of a turbine nozzle endwall 102, 104 including CMC portion/component 130 that forms at least part of nozzle endwall 102, 104 (FIG. 1). A next step of the method according to embodiments of the disclosure includes infiltrating plurality of CMC plies 150, 250 with a binder 170 to form the component. As understood, binder 170 infiltrates CMC plies 150, 250, and hardens therein to form the final component. Binder 170 may include any now known or later developed CMC binding material, e.g., a ceramic slurry. Any necessary curing and/or finishing steps may also be provided, e.g., machining, etc. However, embodiments of the disclosure may also eliminate the need for finishing steps in some circumstances.

Turbine nozzle endwall 102, 104 according to embodiments of the disclosure would include a plurality of CMC plies 150, 250 infiltrated with binder 170. As shown in FIGS. 5-7, at least a first plurality 150 of plurality of CMC plies 150, 250 each define both outer portion 154 and an inner, airfoil engaging portion 152 of the turbine nozzle endwall. Each inner, airfoil engaging portion 152 is defined within outer portion 154 by one or more openings 156 in the respective CMC ply 150. That is, outer portion 154 frames inner portion 152. At least one of the one or more openings 156 in a respective CMC ply 150 includes an offset step relative to a corresponding one or more openings in an adjacent CMC ply 150. Although shown as having a polygonal outer periphery, outer portion 154 may have any desired outer periphery shape. In the example shown, inner, airfoil engaging portion 152 has an internal airfoil-shaped opening 142. A second plurality of the plurality of the CMC plies 250 may each define at least a section of just one of outer portion 154 and inner, airfoil engaging portion 152. In FIGS. 6-8, CMC plies 250 form part of inner portion 152, and in FIG. 8, CMC plies 250 (not shown) may form an upwardly curving portion 172 of outer portion 154.

Embodiments of the disclosure simplify CMC layering by removing the need for a number of smaller preforms and a number of additional CMC layers, increasing the speed in which the layering may occur, and removing the need to machine out openings in the inner portion. In certain application, CMC plies 150 also provide additional surface area (ply drop edges) that provide for better infiltration of binder via capillary action. Embodiments of the disclosure may also eliminate the need for finishing steps, e.g., machining.

It should be noted that in some alternative implementations, the acts noted in the drawings may occur out of the order noted in the figure or, for example, may in fact be executed substantially concurrently or in the reverse order, depending upon the act involved. Also, one of ordinary skill in the art will recognize that additional steps that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method of layering ceramic matrix composite (CMC) plies during a build of a component, the method comprising:
creating a plurality of CMC plies for creating the component, wherein at least a first plurality of the plurality of the CMC plies each define both an outer portion and an inner portion of the component, each inner portion being defined within the outer portion by one or more openings in the respective CMC ply;
layering the plurality of CMC plies; and
infiltrating the plurality of CMC plies with a binder to form the component.

2. The method of claim 1, wherein at least one of the one or more openings in a respective CMC ply includes an offset step relative to a corresponding one or more openings in an adjacent CMC ply.

3. The method of claim 1, wherein the one or more openings in each CMC ply define a negative representation of the inner portion of the component.

4. The method of claim 1, wherein the component includes a turbomachine nozzle endwall, and the inner portion has an internal airfoil-shaped opening.

5. The method of claim 1, wherein at least a second plurality of the plurality of the CMC plies defines at least a section of just one of the outer portion and the inner portion.

6. A method of layering ceramic matrix composite (CMC) plies during a build of turbine nozzle endwall, the method comprising:
creating a plurality of CMC plies for creating the turbine nozzle endwall, wherein at least a first plurality of the plurality of the CMC plies each define both an outer portion and an inner, airfoil engaging portion of the turbine nozzle endwall, each inner, airfoil engaging portion being defined within the outer portion by one or more openings in the respective CMC ply, and wherein the inner, airfoil engaging portion has an internal airfoil-shaped opening;
layering the plurality of CMC plies; and
infiltrating the plurality of CMC plies with a binder to form the component.

7. The method of claim 6, wherein at least one of the one or more openings in a respective CMC ply includes an offset step relative to a corresponding one or more openings in an adjacent CMC ply.

8. The method of claim 6, wherein the one or more openings in each CMC ply define a negative representation of the inner, airfoil engaging portion of the component.

9. The method of claim 6, wherein at least a second plurality of the plurality of the CMC plies defines at least a section of just one of the outer portion and the inner, airfoil engaging portion.

10. A turbine nozzle endwall, the endwall comprising:
a plurality of ceramic matrix composite (CMC) plies infiltrated with a binder,
wherein at least a first plurality of the plurality of the CMC plies each define both an outer portion and an inner, airfoil engaging portion of the turbine nozzle endwall, each inner, airfoil engaging portion being defined within the outer portion by one or more openings in the respective CMC ply, and wherein the inner, airfoil engaging portion has an internal airfoil-shaped opening.

11. The endwall of claim 10, wherein at least one of the one or more openings in a respective CMC ply includes an offset step relative to a corresponding one or more openings in an adjacent CMC ply.

12. The endwall of claim 10, wherein at least a second plurality of the plurality of the CMC plies each define at least a section of just one of the outer portion and the inner, airfoil engaging portion.
